(19) United States
(12) Patent Application Publication
(10) Pub. No.: US 2026/0162671 A1
(43) Pub. Date: Jun. 11, 2026

(54) JOINT MODEL FOR PROFILE-BASED INTENT DETECTION AND SLOT FILLING WITH SLOT-TO-INTENT ATTENTION

(71) Applicant: VINAI ARTIFICIAL INTELLIGENCE APPLICATION AND RESEARCH JOINT STOCK COMPANY, Ha Noi (VN)

(72) Inventors: Quoc Dat Nguyen, Ha Noi (VN); Hoai Phu Thinh Pham, Ha Noi (VN); Hai Hung Bui, Ha Noi (VN)

(21) Appl. No.: 18/970,404

(22) Filed: Dec. 5, 2024

(51) Int. Cl. G10L 25/30; G10L 15/02; G10L 25/51

(52) U.S. Cl. CPC G10L 25/30; G10L 15/02; G10L 25/51

(57) ABSTRACT

Systems and methods for profile-based intent detection and slot filling are aimed at reducing the ambiguity in user utterances by leveraging user-specific supporting profile information. A joint model, referred to as JPIS, is designed to enhance profile-based intent detection and slot filling. JPIS incorporates the supporting profile information into its encoder and introduces a slot-to-intent attention mechanism to transfer slot information representations to intent detection. Experimental results show that JPIS substantially outperforms previous profile-based models, establishing a new state-of-the-art performance in overall accuracy on the benchmark dataset ProSLU.

### BACKGROUND OF THE INVENTION

### 1. Field of the Invention

Embodiments of the invention relate generally to systems and methods of intent detection and slot filling. More particularly, embodiments of the invention relate to methods and systems for profile-based intent detection and slot filling with slot-to-intent attention.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Recent studies on intent detection and slot filling have explored the effectiveness of joint models in enhancing overall performance, thanks to the high inherent correlation between intents and slots. Some research studies introduce frameworks for transferring intent information to the slot filling task, while others propose models that incorporate slot representations as external knowledge in intent detection. Subsequently, numerous joint models have been proposed to leverage the dependencies between the two tasks by integrating attention mechanisms. With the advancements in deep learning and pre-trained language models, joint intent detection and slot filling models have reached a significant overall accuracy of 92-94% on standard benchmark datasets.

Despite achieving strong performance, most existing studies are solely based on plain text, assuming that it suffices to accurately capture intents and slots. However, this assumption may not hold in many real-world situations where user utterances can be ambiguous. For instance, the utterance “Book a ticket to Hanoi” is ambiguous, making it challenging to correctly identify its intent, which could involve booking a plane, train or bus ticket. Therefore, relying solely on the utterances' text to predict their intent and slots may prove insufficient.

The first attempt to address this issue introduced profile-based intent detection and slot filling tasks. These tasks take into account the user's profile information as additional knowledge to mitigate the ambiguity of the user's utterance. In this context, profile information plays a crucial role in predicting intents and slots. In the absence of profile information, even state-of-the-art models, achieve an overall accuracy of at most 44%. Here, a profile-based intent detection and slot filling system can leverage two types of supporting profile information to reduce the ambiguity in utterances: User Profile and Context Awareness. The User Profile comprises a set of user-associated feature vectors representing the probability distribution of user preferences and attributes, such as transportation and audio visual application preferences. Similarly, Context Awareness includes a list of vectors that indicate the user's state and status, including geographic location and the user's movement patterns. Furthermore, a knowledge graph might be utilized as additional information to disambiguate mentions with the same name but different entity types.

While profile-based intent detection and slot filling are two important tasks that reflect real-world scenarios, research into these problems remains under-explored. Currently, there is only one known work that injects supporting profile information into intent detection and slot filling models, achieving the highest overall accuracy at 82.3%.

In view of the foregoing, there is a need for improved methods for intent detection and slot filling that can achieve improved accuracy as compared to conventional methods.

### SUMMARY OF THE INVENTION

Aspects of the present invention provide JPIS—a joint model to further enhance the accuracy performance of profile-based intent detection and slot filling. JPIS incorporates the supporting profile information into its encoder. Additionally, it introduces a slot-to-intent attention mechanism designed to facilitate the transfer of slot information into intent detection. Experiments show that JPIS, according to embodiments of the present invention, achieves a new state-of-the-art overall accuracy at about 86.7% on the benchmark dataset ProSLU. Furthermore, an ablation analysis was conducted to assess the contributions of the slot-to-intent attention mechanism and the integration of supporting profile information.

Embodiments of the present invention provide a non-transitory computer readable storage medium tangibly embodying a computer readable program code having computer readable instructions that, when executed, causes a computer device to carry out a method for profile-based intent detection and slot filling using a joint model for profile-based intent detection and slot filling with slot-to-intent attention (a JPIS model) comprising generating feature vectors for word tokens in an input utterance by incorporating profile information into an utterance encoder; utilizing the generated feature vectors with a slot-to-intent attention to derive label-specific vector representations of intents and slot labels; calculating a similarity feature matrix between intent and slot labels via label-specific vector representations; utilizing the similarity feature matrix for computing an attention weight vector; computing a weighted sum vector based on the attention weight vector and intent label-specific vectors; predicting an intent label of the input utterance by taking the weighted sum vector as input into an intent decoder; and predicting a slot label for each word token in the input utterance using a slot decoder that leverages the representation of the predicted intent label and the generated feature vectors from the utterance encoder.

In some embodiments, the method further comprises employing slot label-specific vectors in the slot-to-intent attention to guide intent detection, resulting in a weighted sum vector of intent label-specific vectors.

In some embodiments, which may be combined with any of the above embodiments, the method further comprises using the weight sum vector as input to the intent decoder.

In some embodiments, which may be combined with any of the above embodiments, the method further comprises, by the utterance encoder creating a vector to represent each word token of the input utterance by concatenating contextual word embeddings; feeding a sequence of real-valued word embeddings into a single bi-directional long short-term memory (LSTM) layer and a single self-attention layer to generate contextual vectors; creating a matrix representing the profile information, by using projection matrices; incorporating the profile information into each word token to apply a multiplicative attention mechanism; and concatenating the generated contextual vector and a profile information vector to obtain the feature vector for each word token.

In some embodiments, which may be combined with any of the above embodiments, the method further comprises, by the slot-to-intent attention, extracting label-specific vector representations with a label attention mechanism; calculating a similarity feature matrix between intent and slot labels by using the label-specific vector representations; permitting information transfer from the slot-to-intent attention by employing the similarity feature matrix for computing an attention weight vector; and utilizing the attention weight vector and the intent label-specific vectors for calculating a weighted sum vector as a final vector representation of the input utterance for intent detection.

In some embodiments, which may be combined with any of the above embodiments, the method further comprises, by the intent decoder, predicting an intent label for the input utterance based on the input weighted sum vector, wherein, during training of the intent decoder, a cross entropy loss is calculated for predicting the intent label.

In some embodiments, which may be combined with any of the above embodiments, the method further comprises, for the slot decoder, representing the predicted intent label from the intent decoder by an embedding vector; concatenating each feature vector with the embedding vector of the predicted intent label to create a slot filling-specific vector; and projecting each slot filling-specific vector into a vector space and applying a linear-chain conditional random field to predict a corresponding slot for each word token, wherein a cross-entropy loss is computed for slot filling during training of the slot decoder.

In some embodiments, which may be combined with any of the above embodiments, the method further comprises minimizing, during training of the JPIS model, a final training objective loss, which is a weighted sum of the cross entropy loss for predicting the intent label and the cross entropy loss for slot filling.

Embodiments of the present invention provide a profile-based intent detection and slot filling system comprising an utterance encoder incorporating profile information to generate feature vectors for word tokens in an input utterance; a slot-to-intent attention utilizing the generated feature vectors to derive label-specific vector representations of intents and slot labels; utilizing the label-specific vector representations to calculate a similarity feature matrix between intent and slot labels; computing an attention weight vector based on the similarity feature matrix; utilizing the attention weight vector and intent label-specific vectors for computing a weighted sum vector; an intent decoder taking the weighted sum vector as input to predict an intent label of the input utterance; and a slot decoder leveraging the representation of the predicted intent label and the generated feature vectors from the utterance encoder to predict a slot label for each word token in the input utterance.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates an overall architecture of a joint model for profile-based intent detection and slot filling with slot-to-intent attention, referred to as JPIS, according to an exemplary embodiment of the present invention;

FIG. 2 illustrates Table 1, showing obtained results without pre-trained language model (PLM), noting that all the baseline models have already been expanded to incorporate supporting profile information, and the reported results for these baseline models are taken from the literature;

FIG. 3 illustrates Table 2, showing overall accuracies with PLMs, where the results reported for the baseline model “General-SLU” are taken from the literature; and

FIG. 4 illustrates Table 3, showing ablation results.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G or the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide systems and methods for profile-based intent detection and slot filling, aimed at reducing the ambiguity in user utterances by leveraging user-specific supporting profile information. A joint model, referred to as JPIS, is designed to enhance profile-based intent detection and slot filling. JPIS incorporates the supporting profile information into its encoder and introduces a slot-to-intent attention mechanism to transfer slot information representations to intent detection. Experimental results show that JPIS substantially outperforms previous profile-based models, establishing a new state-of-the-art performance in overall accuracy on the benchmark dataset ProSLU.

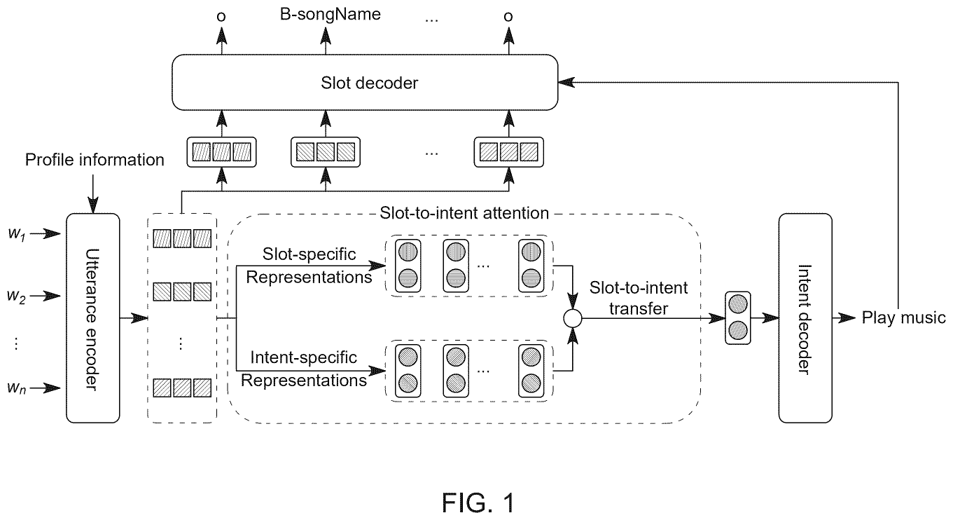

The profile-based intent detection and slot filling tasks are formulated as sequence classification and BIO scheme-based token classification problems, respectively. FIG. 1 illustrates the architecture of the JPIS model, according to embodiments of the present invention, which comprises four main components: (i) utterance encoder, (ii) slot-to-intent attention, (iii) intent decoder and (iv) slot decoder. Here, the utterance encoder incorporates the supporting profile information to generate feature vectors for word tokens in the input utterance. The slot-to-intent attention component utilizes these features to derive label-specific vector representations of intents and slot labels. It then employs slot label-specific vectors to guide intent detection, resulting in a weighted sum vector of intent label-specific vectors. The intent decoder component takes this weighted sum vector as input to predict the intent label of the input utterance. Finally, the slot decoder leverages the representation of the predicted intent label and word-level feature vectors from the utterance encoder to predict a slot label for each word token in the input.

Utterance Encoder: Given an input utterance with n word tokens ω₁, w₂, . . . ωₙ, the utterance encoder first creates a vector eᵢ∈ [symbol] ^{d}^{ₑ} to represent the i-th word token ωᵢ by concatenating contextual word embeddings

$${e}_{i}^{BiLSTM} and {e}_{i}^{SA} :$$

$${e}_{i} = {e}_{i}^{BiLSTM} ⊕ {e}_{i}^{SA} . \qquad ( 1 )$$

Here, a sequence of real-valued word embeddings e_{ω}_{₁}, e_{ω}_{₂}, . . . e_{ω}_{ₙ} are fed into a single bi-directional long short-term memory (LSTM) layer and a single self-attention layer to generate the contextual vectors

$${e}_{i}^{BiLSTM} and {e}_{i}^{SA} ,$$

respectively.

Given that the supporting profile information for the input utterance includes m user-associated feature vectors

$${x}_{1}^{UP} , … {x}_{m}^{UP}$$

and t context awareness vectors

$${x}_{1}^{CA} , … {x}_{t}^{CA} .$$

The utterance encoder creates a matrix [symbol] ∈ [symbol] ^{d}^{ₚ}^{×(m+t)} representing the profile information, by using projection matrices

$${W}_{j}^{UP} and {W}_{j}^{CA} :$$

$${p}_{j}^{UP} = {W}_{j}^{UP} {x}_{j}^{UP} \qquad ( 2 )$$

$${P}_{j}^{CA} = {W}_{j}^{CA} {x}_{j}^{CA} \qquad ( 3 )$$

$$P = [ {p}_{1}^{UP} , … , {p}_{m}^{UP} , {p}_{1}^{CA} , … , {p}_{t}^{CA} ] \qquad ( 4 )$$

To incorporate the supporting profile information into each input word token, the multiplicative attention mechanism is applied:

$${α}_{i , j} = \frac{exp ( {e}_{i} {W}^{P} {P}_{* , j} )}{{\sum }_{k = 1}^{m + t} exp ( {e}_{i} {W}^{P} {P}_{* , k} )} \qquad ( 5 )$$

$${e}_{i}^{′} = {\sum }_{j = 1}^{m + t} {α}_{i , j} {P}_{* , j} \qquad ( 6 )$$

where W^{P}∈ [symbol] ^{d}^{ₑ}^{×d}^{ₚ} is a weight matrix, and P*, j denotes the j-th column vector of the profile representation matrix P.

For the i-th word token, its contextual vector eᵢ and its profile information vector

$${e}_{i}^{′}$$

are concatenated to obtain the final vector uᵢ∈ [symbol] ^{d}^{ᵤ} where dᵤ=dₑ+dₚ. Vectors uᵢ are concatenated to formulate an encoding matrix U∈ [symbol] ^{d}^{ᵤ}^{×n} as:

$${u}_{i} = {e}_{i} ⊕ {e}_{i}^{′} \qquad ( 7 )$$

$$U = [ {u}_{1} , {u}_{2} , … , {u}_{n} ] \qquad ( 8 )$$

Slot-to-Intent Attention: Most previous joint models consider aligning the importance of intent information to guide slot filling. However, research has demonstrated that employing slot filling could also enhance intent detection. Therefore, a simple yet effective slot-to-intent attention mechanism is introduced herein for integrating slot information into intent detection.

The slot-to-intent attention mechanism, according to embodiments of the present invention, first adapts the label attention mechanism to extract label-specific vector representations. Formally, U is taken as input to compute label specific attention weight matrices A^{I} and A^{S}, then multiply U with these attention weight matrices to obtain label-specific representation matrices V^{I}∈ [symbol] ^{d}^{ᵤ}^{×|L}^{^{I}}^{|} and V^{S}∈ [symbol] ^{d}^{ᵤ}^{×|L}^{^{S}}^{|}:

$${A}^{I} = softmax ( {Z}^{I} \times tanh ( {Q}^{I} \times U ) ) \qquad ( 9 )$$

$${A}^{S} = softmax ( {Z}^{S} \times tanh ( {Q}^{S} \times U ) ) \qquad ( 10 )$$

$${V}^{I} = U \times {( {A}^{I} )}^{T} \qquad ( 11 )$$

$${V}^{S} = U \times {( {A}^{S} )}^{T} \qquad ( 12 )$$

where softmax is performed at the row level; and Z^{I}∈ [symbol] ^{|L}^{^{I}}^{|×d}^{ₐ}, Z^{S}∈ [symbol] ^{|L}^{^{S}}^{|×d}^{ₐ}, and Q^{I}, Q^{S}∈ [symbol] ^{d}^{ₐ}^{×d}^{ᵤ} are weight matrices. Here, L^{I} and L^{S} are the intent label set and slot label set, respectively. The j-th column vectors

$${V}_{* , j}^{I} and {V}_{* , j}^{S}$$

are referred to as representation vectors of the input utterance with respect to the j-th label in L^{I} and L^{S}, respectively.

The slot-to-intent attention mechanism then simplifies the parallel co-attention to calculate the similarity between intent and slot labels by using the label-specific representations V^{I} and V^{S}. Specifically, it computes a bilinear attention matrix C∈ [symbol] ^{|L}^{^{S}}^{|×|L}^{^{I}}^{|} between intent and slot label types as:

$$C = tanh ( {( {V}^{S} )}^{T} \times {W}^{C} \times {V}^{I} ) \qquad ( 13 )$$

where W^{C}∈ [symbol] ^{d}^{ᵤ}^{×d}^{ᵤ} is a weight matrix.

After that, the mechanism allows information transfer from slot to intent by employing C as a feature matrix for computing an attention weight vector a∈ [symbol] ^{|L}^{^{I}}^{|} as:

$$H = tanh ( {W}^{I} \times {V}^{I} + ( {W}^{S} \times {V}^{S} ) \times C ) \qquad ( 14 )$$

$$a = softmax ( {w}^{a} \times H ) \qquad ( 15 )$$

where W^{I}, W^{S}∈ [symbol] ^{d}^{_{c}}^{×d}^{ᵤ} and w^{a}∈ [symbol] ^{d}^{_{c}}.

The final vector representation of the input utterance for intent detection is calculated as the weighted sum of the intent label-specific column vectors

$${V}_{* , j}^{I} .$$

$$g - {\sum }_{j = 1}^{\vert {L}^{\text{?}} \vert} {a}_{j} {V}_{* , j}^{I} \qquad ( 16 )$$

$$\text{?} \text{indicates text missing or illegible when filed}$$

Intent Decoder: The intent decoder takes g∈ [symbol] ^{d}^{ᵤ} to predict the intent label y^{I}=argmax(softmax(W^{ID}g)) for the input utterance (here, W^{ID}∈ [symbol] ^{|L}^{^{I}}^{|×d}^{ᵤ}). During training, a cross entropy loss [symbol] _{ID} is calculated for predicting the label y^{I}.

[symbol]

Slot Decoder: To align the importance of the intent with each input token (i.e., intent-to-slot information transfer), the slot decoder also represents the predicted intent label y^{I} from the intent decoder by an embedding vector e_{y}_{^{I}}∈ [symbol] ^{d}^{_{y}}. Then it concatenates each feature vector uᵢ(from Equation 8) with e_{y}_{^{I}} to create a slot filling-specific vector sᵢ:

$${s}_{i} = {u}_{i} ⊕ {e}_{y} \text{?} \qquad ( 17 )$$

$$\text{?} \text{indicates text missing or illegible when filed}$$

The slot decoder projects each sᵢ into the 2|L^{S}|+1 vector space and applies a linear-chain conditional random field (CRF) to predict the corresponding slot for the i-th token. Here, 2|L^{S}|+1 is the number of BIO-based slot tag labels (including the “O” label). Across-entropy loss [symbol] _{SF} is computed for slot filling during training while the Viterbi algorithm is used for inference.

Joint Training: The final training objective loss [symbol] is a weighted sum of the intent detection and slot filling losses:

$$ℒ = {λℒ}_{ID} + ( 1 - λ ) {ℒ}_{SF} \qquad ( 18 )$$

### Experiments

Benchmark dataset and Evaluation metrics. Experiments were conducted on the Chinese dataset ProSLU, which is the only publicly available benchmark with supporting profile information. ProSLU consists of 4196, 522 and 531 utterances for training, validation and test, respectively. Here, each utterance has 4 user-associated feature vectors and 4 context awareness vectors (i.e., m=4 and t=4).

Standard evaluation metrics were used, including intent accuracy for intent detection, slot F₁ score for slot filling, and overall accuracy which is the percentage of utterances where both intent and slots are correctly predicted.

Implementation details. In the utterance encoder component, the dimensionality of the self-attention layer output was set to 128 and the dimensionality of the LSTM hidden states in the BiLSTM was set to 64, resulting in dₑ=128+64*2=256. Also, dₚ was set to 128, dₐ was set to 128, dₑ was set to 256 and d_{y} was set to 128, thus making dᵤ=dₑ+dₚ=384.

Another setting of utilizing pretrained language models (PLMs) was part of the experiments, considering the representation of the first sub-word as the word representation. That is, eᵢ from Equation 1 is now computed as eᵢ=PLM(w_{1:n}, i).

The model parameters were initialized randomly and the Adam optimizer was used to optimize L with a batch size of 32 and a dropout rate of 0.4. A grid search was performed on the validation set, selecting the Adam initial learning rate from {2e-4, 4e-4, 6e-4, 8e-4} and the mixture weight λ from {0.1, 0.2, . . . , 0.9}. The model is trained for 50 epochs, and the checkpoint with the highest overall accuracy on the validation set was chosen for evaluation on the test set. All the results reported are averages from 5 runs with 5 different random seeds.

### Results

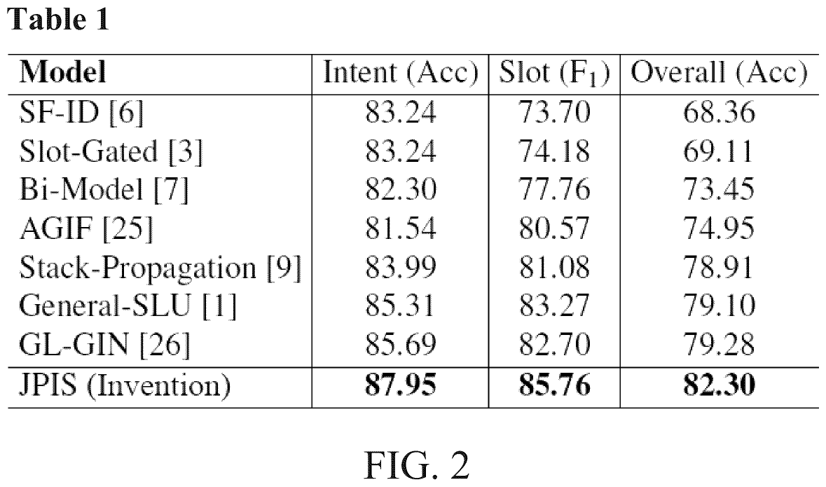

Results without PLM: Table 1, provided as FIG. 2, presents performance results obtained without the use of a PLM for the JPIS model, according to embodiments of the present invention, and competitive baselines on the test set.

Table 1 shows that the JPIS model outperforms all the previous baselines across all three evaluation metrics. In particular, when compared to the previous best results, JPIS achieves substantial absolute performance improvements ranging from 2.5% to 3.0% in all three metrics. The most substantial improvement is observed in overall accuracy, which has increased from 79.28% to 82.30%. This clearly demonstrates the effectiveness of both intent-to-slot and slot-to-intent information transfer within the model architecture. It is also worth noting that the supporting profile information is utilized effectively, resulting in a positive impact on utterance representations and enhancing the interaction between intent and slot labels through the label encoder.

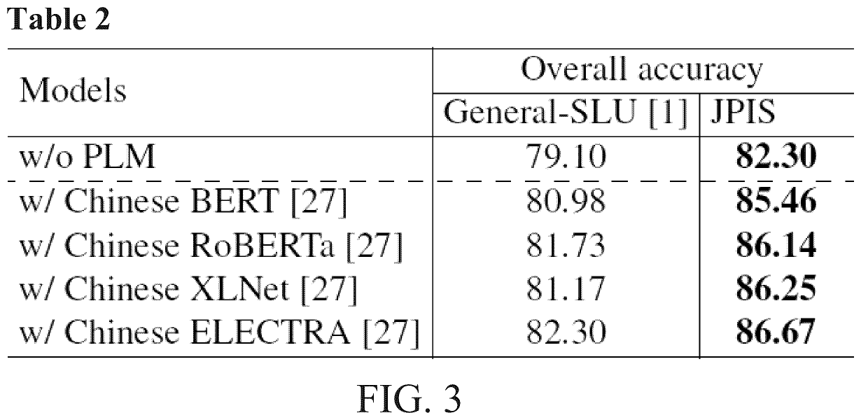

State-of-the-art results with PLM: The overall accuracy results achieved with PLMs on the test set are also reported. Table 2, provided as FIG. 3, presents obtained results comparing the JPIS, according to embodiments of the present invention, and the baseline “General-SLU” when combined with different PLMs. Unsurprisingly, the PLMs generating high quality contextual word representations notably contribute to improving the performance of both JPIS and “General-SLU”, resulting in overall accuracy increases of about 2% to 4.4%. Clearly, JPIS consistently outperforms “General-SLU” by substantial margins across all experimented PLMs, achieving absolute improvements ranging from 4.4% to 5.1%, establishing a new state-of-the-art overall accuracy at 86.67%.

Ablation study. An ablation study was conducted to investigate the contributions of the model components according to embodiments of the present invention.

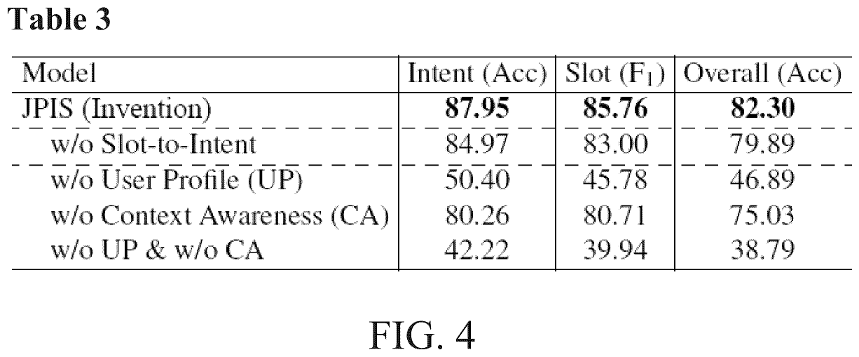

Effect of slot-to-intent attention: To verify the effectiveness of the slot-to-intent attention component, an experiment was conducted where this component is removed from the model (denoted by “w/o Slot-to-Intent” in Table 3, provided as FIG. 4). The calculation of the vector representation g of the input utterance for intent detection was adjusted, as shown in Equation 16, to the following common attention-based form: g=softmax(w^{g}×U)×U^{T}.

It was found that removing the slot-to-intent attention resulted in a noticeable decrease of 3% in intent accuracy. It also caused a reduction in slot F₁ by 2.8% and an overall accuracy drop of 2.4%. These findings provide clear evidence of the slot-to-intent attention's notable contribution by using slot-specific representations to enhance the prediction of intent labels.

Effect of supporting profile information: The impact of different profile information types on the model's performance was evaluated. In particular, the following experiments were conducted: (i) without utilizing user profile (UP), i.e., adjusting Equation 4 as

$$P = [ {p}_{1}^{CA} , … , {p}_{t}^{CA} ] ;$$

(ii) without utilizing context awareness (CA), i.e. adjusting Equation 4 as

$$P = [ {p}_{1}^{UP} , … , {p}_{m}^{UP} ] ;$$

(iii) without both UP and CA, adjusting Equation 8 as U=[e₁, e₂, . . . , eₙ]. The results, as shown in Table 3 (FIG. 4), demonstrate significant decreases in all three evaluation metrics for all three ablated model settings: without UP, without CA and without both UP and CA. Clearly, the model incorporates the supporting profile information effectively.

### CONCLUSION

In conclusion, embodiments of the present invention provides JPIS, a joint model for profile-based intent detection and slot filling. JPIS seamlessly integrates supporting profile information and introduces a slot-to-intent attention mechanism to facilitate knowledge transfer from slot labels to intent detection. Experiments on the Chinese benchmark dataset ProSLU show that JPIS achieves a new state-of-the-art performance, surpassing previous models by a substantial margin.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for profile-based intent detection and slot filling using a joint model for profile-based intent detection and slot filling with slot-to-intent attention (a JPIS model), comprising:
generating feature vectors for word tokens in an input utterance by incorporating profile information into an utterance encoder;
utilizing the generated feature vectors with a slot-to-intent attention to derive label-specific vector representations of intents and slot labels;
calculating a similarity feature matrix between intent and slot labels via label-specific vector representations;
utilizing the similarity feature matrix for computing an attention weight vector;
computing a weighted sum vector based on the attention weight vector and intent label-specific vectors;
predicting an intent label of the input utterance by taking the weighted sum vector as input into an intent decoder; and
predicting a slot label for each word token in the input utterance using a slot decoder that leverages the representation of the predicted intent label and the generated feature vectors from the utterance encoder.

2. The method of claim 1, further comprising employing slot label-specific vectors in the slot-to-intent attention to guide intent detection, resulting in a weighted sum vector of intent label-specific vectors.

3. The method of claim 2, wherein using the weight sum vector as input to the intent decoder.

4. The method of claim 1, further comprising, by the utterance encoder:
creating a vector to represent each word token of the input utterance by concatenating contextual word embeddings;
feeding a sequence of real-valued word embeddings into a single bi-directional long short-term memory (LSTM) layer and a single self-attention layer to generate contextual vectors;
creating a matrix representing the profile information, by using projection matrices;
incorporating the profile information into each word token to apply a multiplicative attention mechanism; and
concatenating the generated contextual vector and a profile information vector to obtain the feature vector for each word token.

5. The method of claim 1, further comprising, by the slot-to-intent attention:
extracting label-specific vector representations with a label attention mechanism;
calculating the similarity feature matrix between intent and slot labels by using the label-specific vector representations;
permitting information transfer from the slot-to-intent attention by employing the similarity feature matrix for computing an attention weight vector; and
utilizing the attention weight vector and the intent label-specific vectors for calculating a weighted sum vector as a final vector representation of the input utterance for intent detection.

6. The method of claim 1, further comprising, by the intent decoder:
predicting an intent label for the input utterance based on the weighted sum vector, wherein, during training of the intent decoder, a cross entropy loss is calculated for predicting the intent label.

7. The method of claim 6, further comprising, for the slot decoder:
representing the predicted intent label from the intent decoder by an embedding vector;
concatenating each feature vector with the embedding vector of the predicted intent label to create a slot filling-specific vector; and
projecting each slot filling-specific vector into a vector space and applying a linear-chain conditional random field to predict a corresponding slot for each word token, wherein a cross-entropy loss is computed for slot filling during training of the slot decoder.

8. The method of claim 7, further comprising minimizing, during training of the JPIS model, a final training objective loss, which is a weighted sum of the cross entropy loss for predicting the intent label and the cross entropy loss for slot filling.

9. A profile-based intent detection and slot filling system, comprising:
an utterance encoder incorporating profile information to generate feature vectors for word tokens in an input utterance;
a slot-to-intent attention utilizing the generated feature vectors to derive label-specific vector representations of intents and slot labels;
utilizing the label-specific vector representations to calculate a similarity feature matrix between intent and slot labels;
computing an attention weight vector based on the similarity feature matrix;
utilizing the attention weight vector and intent label-specific vectors for computing a weighted sum vector;
an intent decoder taking the weighted sum vector as input to predict an intent label of the input utterance; and
a slot decoder leveraging the representation of the predicted intent label and the generated feature vectors from the utterance encoder to predict a slot label for each word token in the input utterance.

10. The system of claim 9, wherein the slot-to-intent attention further employs slot label-specific vectors to guide intent detection, resulting in a weighted sum vector of intent label-specific vectors.

11. The system of claim 10, wherein the intent decoder uses the weighted sum vector as input.

12. A non-transitory computer readable storage medium tangibly embodying a computer readable program code having computer readable instructions that, when executed, causes a computer device to carry out a method for profile-based intent detection and slot filling using a joint model for profile-based intent detection and slot filling with slot-to-intent attention (a JPIS model), the method comprising:
generating feature vectors for word tokens in an input utterance by incorporating profile information into an utterance encoder;
utilizing the generated feature vectors with a slot-to-intent attention to derive label-specific vector representations of intents and slot labels;
calculating a similarity feature matrix between intent and slot labels via label-specific vector representations;
utilizing the similarity feature matrix for computing an attention weight vector;
computing a weighted sum vector based on the attention weight vector and intent label-specific vectors;
predicting an intent label of the input utterance by taking the weighted sum vector as input into an intent decoder; and
predicting a slot label for each word token in the input utterance using a slot decoder that leverages the representation of the predicted intent label and the generated feature vectors from the utterance encoder.

13. The non-transitory computer readable storage medium of claim 12, wherein the method further comprises employing slot label-specific vectors in the slot-to-intent attention to guide intent detection, resulting in a weighted sum vector of intent label-specific vectors.

14. The non-transitory computer readable storage medium of claim 13, wherein using the weight sum vector as input to the intent decoder.

15. The non-transitory computer readable storage medium of claim 12, wherein the method further comprises, by the utterance encoder:
creating a vector to represent each word token of the input utterance by concatenating contextual word embeddings;
feeding a sequence of real-valued word embeddings into a single bi-directional long short-term memory (LSTM) layer and a single self-attention layer to generate contextual vectors;
creating a matrix representing the profile information, by using projection matrices;
incorporating the profile information into each word token to apply a multiplicative attention mechanism; and
concatenating the generated contextual vector and a profile information vector to obtain the feature vector for each word token.

16. The non-transitory computer readable storage medium of claim 12, wherein the method further comprises, by the slot-to-intent attention:
extracting label-specific vector representations with a label attention mechanism;
calculating the similarity feature matrix between intent and slot labels by using the label-specific vector representations;
permitting information transfer from the slot-to-intent attention by employing the similarity feature matrix for computing an attention weight vector; and
utilizing the attention weight vector and the intent label-specific vectors for calculating a weighted sum vector as a final vector representation of the input utterance for intent detection.

17. The non-transitory computer readable storage medium of claim 12, wherein the method further comprises, by the intent decoder:
predicting an intent label for the input utterance based on the input weighted sum vector, wherein, during training of the intent decoder, a cross entropy loss is calculated for predicting the intent label.

18. The non-transitory computer readable storage medium of claim 17, wherein the method further comprises, for the slot decoder:
representing the predicted intent label from the intent decoder by an embedding vector;
concatenating each feature vector with the embedding vector of the predicted intent label to create a slot filling-specific vector; and
projecting each slot filling-specific vector into a vector space and applying a linear-chain conditional random field to predict a corresponding slot for each word token, wherein a cross-entropy loss is computed for slot filling during training of the slot decoder.

19. The non-transitory computer readable storage medium of claim 18, wherein the method further comprises minimizing, during training of the JPIS model, a final training objective loss, which is a weighted sum of the cross entropy loss for predicting the intent label and the cross entropy loss for slot filling.
